(19) United States
(12) Patent Application Publication
(10) Pub. No.: US 2026/0060218 A1
(43) Pub. Date: Mar. 5, 2026

(54) Bird bath

(71) Applicant: Netvue Technologies Co., Ltd., Nanshan District (CN)

(72) Inventors: Rui Zhang, Nanshan District (CN); Youle Hu, Nanshan District (CN)

(73) Assignee: Netvue Technologies Co., Ltd., Nanshan District (CN)

(21) Appl. No.: 19/315,735

(22) Filed: Sep. 1, 2025

(30) Foreign Application Priority Data
Sep. 5, 2024 (CN) 202411244757.5
Sep. 5, 2024 (CN) 202422174367.7

(51) Int. Cl. A01K 45/00; A01K 29/00; G03B 29/00

(52) U.S. Cl. CPC A01K 45/002; A01K 29/005; G03B 29/00

(57) ABSTRACT

This application relates to a bird bath. The bird bath includes a main body, a fountain device, and a photographing assembly. The main body is provided with a bathing trough for birds to bathe. The fountain device is mounted in the main body. The photographing assembly is disposed around the main body and configured to photograph the birds. A photographing end of the photographing assembly is oriented toward the fountain device. In the bird bath of this application, the bird bath includes the main body, the fountain device, and the photographing assembly. Through the photographing assembly, a user can truly observe scenes of the birds bathing, playing in water, and drinking in the main body, without missing exciting and interesting moments, thereby meeting the user's needs for bird watching and recording, and providing the user with vivid and interesting watching experience.

### CROSS-REFERENCE TO RELATED APPLICATIONS

This application claims priority to Chinese Patent Application No. CN2024221743677 entitled "BIRD BATH" and Chinese Patent Application No. CN2024112447575 entitled "BIRD BATH", filed with the China National Intellectual Property Administration on September 5, 2024, which are incorporated herein by reference in its entirety.

### TECHNICAL FIELD

This application relates to the technical field of bird observation, and in particular, to a bird bath.

### BACKGROUND

To create natural and ecological landscape scenarios, many parks may be provided with bird baths for birds to bathe and drink. The bird baths become places for birds to rest, forage, and play. The bird baths in the prior art can provide some convenience for birds. For example, Chinese patent CN216931431U discloses a new type of bird bath, where a main body of the bird bath is provided with a bathing trough and a feed trough. The bathing water is separated from the drinking water, making the drinking water cleaner and safer. However, this bird bath is functionally limited, makes it inconvenient to record or observe birds in real time, and is prone to miss exciting moments.

### SUMMARY

An objective of this application is to provide a bird bath to solve the problems that the bird bath is functionally limited, makes it inconvenient to record or observe birds in real time, and is prone to miss exciting moments.

To achieve the above objective, this application puts forward the following technical solutions:

A bird bath is provided, including:

a main body, provided with a bathing trough for birds to bathe;

a fountain device, mounted in the main body; and

a photographing assembly, disposed around the main body and configured to photograph the birds, wherein a photographing end of the photographing assembly is oriented toward the fountain device.

In one embodiment, a standard interface is disposed in the main body.

In one embodiment, the standard interface is configured to adapt to the fountain device in a detachable and replaceable manner; the standard interface is disposed at a center of the main body, the standard interface is provided with an accessory slot, and the fountain device is detachably adapted to the accessory slot.

In one embodiment, the fountain device is provided with a water inlet, a water outlet separated from the water inlet and configured to sprinkle water, and a water pump located between the water inlet and the water outlet.

In one embodiment, the bird bath further includes a photovoltaic panel. The photovoltaic panel is disposed at an end of the fountain device, the end being away from the main body. The photovoltaic panel is electrically connected to the water pump.

In one embodiment, a sealing element is disposed between the fountain device and the main body. The sealing element is configured to prevent the water in the main body from leaking from an assembly clearance between the main body and the fountain device.

In one embodiment, the photographing assembly includes a housing and a camera. The camera is disposed in the housing; and/or a top edge of the housing is provided with a flange extending along a horizontal direction, and a top of the flange is overlaid with a solar panel electrically connected to the camera.

In one embodiment, the bird bath further includes a temperature regulation module. The temperature regulation module is configured to heat, cool, or maintain a constant temperature for the main body or gas and/or water in the main body.

In one embodiment, the bird bath further includes a light emitter configured to provide light therapy for birds in the main body.

In one embodiment, the light emitter includes an ultraviolet light-emitting unit and/or a white light-emitting unit. The ultraviolet light-emitting unit is configured to emit ultraviolet rays capable of disinfecting and sterilizing the interior of the main body. The white light-emitting unit is configured to emit full-spectrum light that simulates sunlight.

In one embodiment, the bird bath further includes a vibrator. The vibrator is configured to provide vibration waves for water in the main body.

In one embodiment, the bird bath further includes a spray humidifier. The spray humidifier is configured to spray water mist into the main body.

In one embodiment, the bird bath further includes a water pump. A water tank is mountable outside the main body. The water tank is configured to store water for birds to drink. The water pump is able to pump the water from the water tank into the main body.

In one embodiment, the bird bath further includes a drain valve. The drain valve is configured to quickly drain the water from the main body.

In one embodiment, the bird bath further includes an ozone disinfection unit and a filter purification unit. The ozone disinfection unit and the filter purification unit are configured to filter, purify, and disinfect water in the main body.

In one embodiment, the bird bath further includes a water level sensor configured to sense a water level in the main body.

In one embodiment, the bird bath further includes a water quality sensor configured to sense water quality information in the main body.

In one embodiment, the bottom of the main body is detachably connected to a support assembly. The support assembly includes a vertical post extending along a vertical direction.

In one embodiment, the bird bath further includes a resting board. The resting board is disposed in the main body. The resting board is configured to carry birds.

In one embodiment, an edge of the main body is provided with a socket. The photographing assembly is detachably connected to the socket.

As can be seen from the above technical solutions, this application exhibits at least the following advantages and beneficial effects over the prior art: in the bird bath in an embodiment of this application, the bird bath includes the main body, the fountain device, and the photographing assembly. Through the photographing assembly, a user can truly observe scenes of the birds bathing, playing in water, and drinking in the main body, without missing exciting and interesting moments, thereby meeting the user's needs for bird watching and recording, and providing the user with vivid and interesting watching experience.

### BRIEF DESCRIPTION OF DRAWINGS

To describe the technical solutions in the specific embodiments of this application or the prior art more clearly, the following outlines the drawings that need to be used in the descriptions of the specific embodiments of this application or the prior art. In all the drawings, similar elements or parts are generally identified by similar reference numerals. The elements or parts in the drawings are not necessarily drawn to scale.

FIG. 1 is an overall schematic structural diagram of a bird bath according to this application;

FIG. 2 is a schematic exploded view of the bird bath shown in FIG. 1;

FIG. 3 is a schematic back view of a photographing assembly of a bird bath according to this application;

FIG. 4 is a schematic structural diagram of assembling a main body of a bird bath onto a support assembly according to this application;

FIG. 5 is a schematic exploded view of a support assembly of a bird bath according to this application;

FIG. 6 is a close-up view of a part X in the bird bath shown in FIG. 5;

FIG. 7 is a schematic diagram of a bird bath according to other embodiments of this application;

FIG. 8 is a schematic diagram of a bird bath according to other embodiments of this application;

FIG. 9 is a schematic diagram of a bird bath according to other embodiments of this application;

FIG. 10 is a schematic diagram of a bird bath according to other embodiments of this application;

FIG. 11 is a schematic diagram of a bird bath according to other embodiments of this application; and

FIG. 12 is a schematic diagram of a bird bath according to other embodiments of this application.

### List of reference signs:

1. main body;

11. socket;

100. standard interface;

101. bottom plate;

102. peripheral plate;

111. snap buckle;

112. notch;

12. accessory slot;

121. sealing platform;

2. photographing assembly;

21. housing;

211. window;

212. snap slot;

213. flange;

22. camera;

23. solar panel;

3. resting board;

31. clearance opening;

3a. arcuate block;

4. support assembly;

41. vertical post;

4111. assembly hole;

42. pedestal;

421. arcuate through-hole;

422. spring leaf;

43. drill bit;

44. support seat;

45. fastener;

46. adjustment piece;

47. pin;

48. rope;

49. rotation rod;

5. fountain device;

51. shell;

511. water inlet;

518. water outlet;

52. water pump;

53. outlet pipe;

54. photovoltaic panel;

6. sealing element;

210. temperature regulation module;

2101a. first temperature sensing unit;

2101b. second temperature sensing unit;

2102. heating unit;

2103. heat dissipation unit;

2104. control chip;

2105. first heat conductor;

2106. second heat conductor;

220. accessory shell;

300. light emitter;

301. ultraviolet light-emitting unit;

302. white light-emitting unit;

310. light processing chip;

320. program memory;

330. ambient light sensor;

340. optical proximity sensor;

400. vibrator;

410. high-frequency motor;

420. transmission mechanism;

430. vibration plate;

500. spray humidifier;

510. water tank;

520. high-pressure pump;

530. mist nozzle;

600. water pump;

610. water supply pipe;

620. water delivery pipe;

630. drain valve;

640. drain port;

650. water supply processor;

660. water quality sensor;

670. water level sensor;

710. ozone disinfection unit;

720. filter purification unit;

730. filter cavity;

1000. water tank.

### DETAILED DESCRIPTION

To more clearly explain the objectives, technical solutions, and advantages of this application, the technical solutions in some embodiments of this application will be clearly and completely described below with reference to the drawings in the embodiments of this application. Obviously, the described embodiments are merely a part of the embodiments rather than all embodiments of this application. The exemplary embodiments may be implemented in various forms, and this application is not limited to the examples enumerated herein. Rather, providing the embodiments makes this application more comprehensive and complete, and comprehensively conveys the concepts of the exemplary embodiments to those skilled in the art.

In addition, the features, structures, or characteristics described may be combined in one or more embodiments in any appropriate manner. In the following description, many details are provided to enable thorough understanding of the embodiments of this application. However, a person skilled in the art is aware that the technical solutions of this application can be practiced without one or more of the specific details, or other methods, components, devices, steps, or the like may be adopted instead. In other cases, well-known methods, devices, implementations, or operations are not shown or described in detail for fear of obscuring aspects of this application.

The block diagrams shown in the drawings are merely functional entities, not necessarily corresponding to physically independent entities. In other words, such functional entities may be implemented in software form, or the functional entities may be implemented in one or more hardware modules or integrated circuits, or the functional entities may be implemented in different networks and/or processor devices and/or microcontroller devices.

The flowcharts shown in the drawings are merely exemplary illustrations, but do not necessarily include all contents and operations or steps, and the operations or steps are not necessarily performed in the described order. For example, some operations or steps may be split while other operations or steps may be combined or partially combined. Therefore, the actual execution order may change according to actual situations.

The following describes this application in detail with reference to specific embodiments.

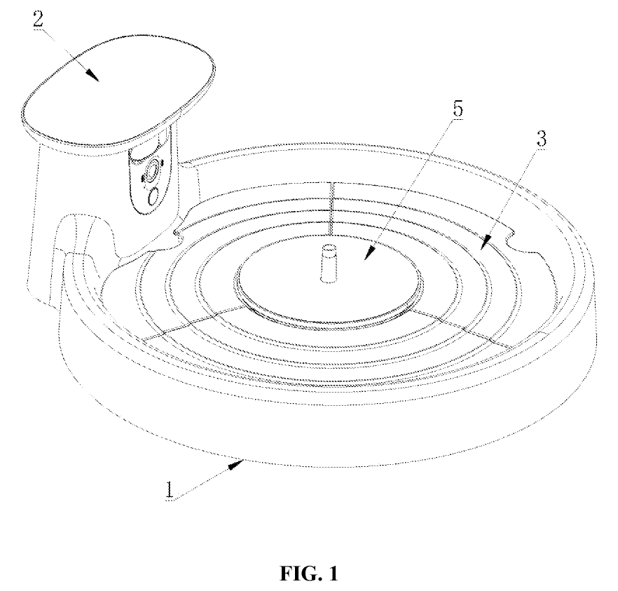

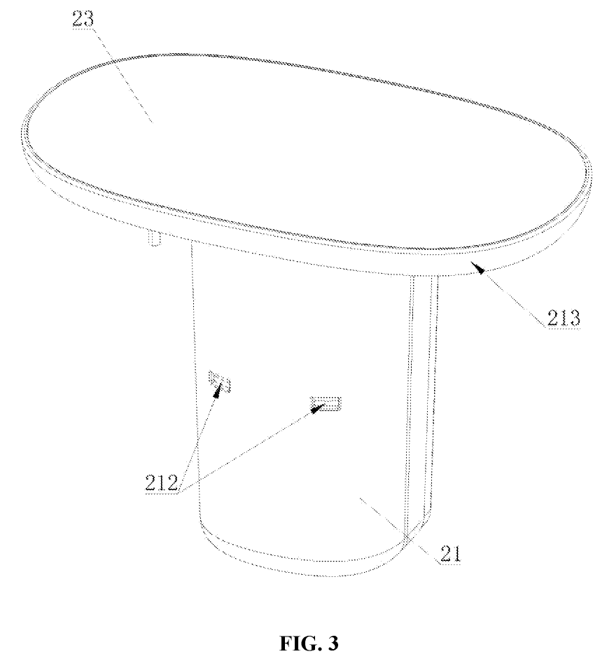

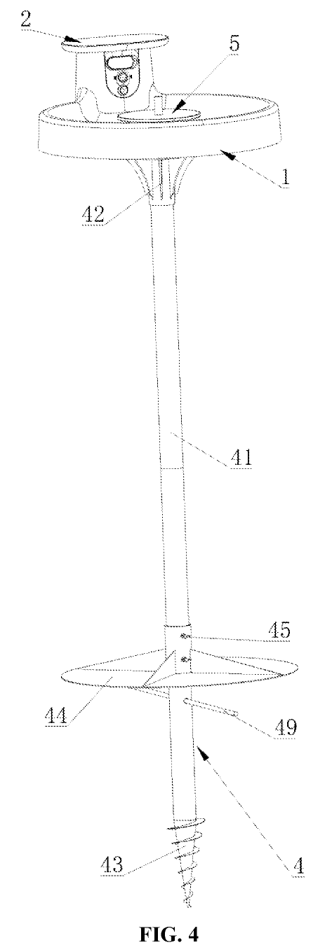

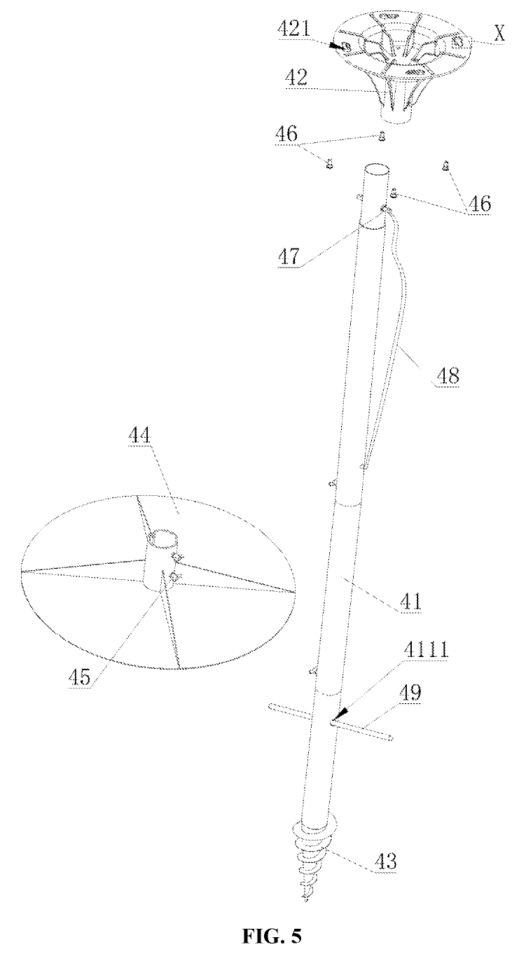

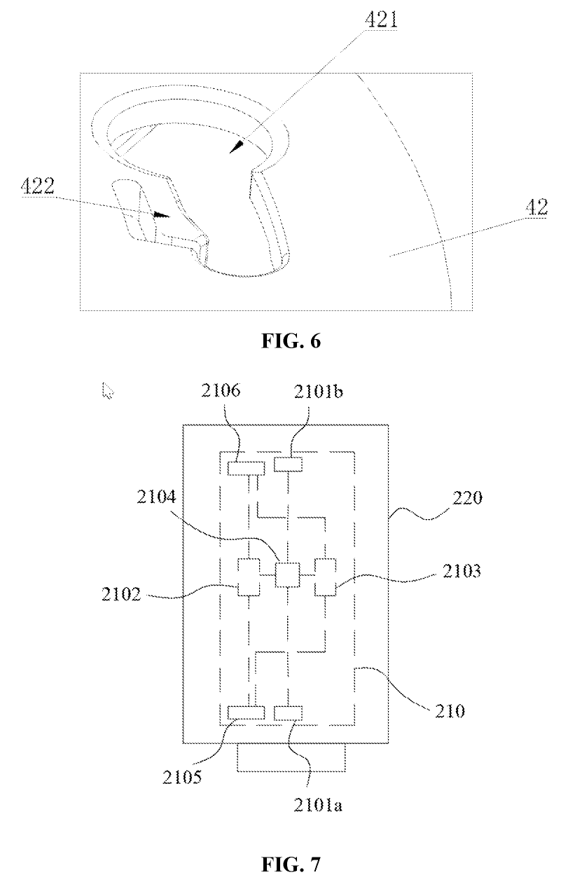

As shown in FIGS. 1 to 6, an embodiment provides a bird bath. The bird bath includes a main body 1. An edge of the main body 1 is provided with a socket 11. Within the socket 11, a photographing assembly 2 is detachably connected. The photographing assembly 2 is disposed around the main body. The photographing assembly 2 is configured to photograph birds. A photographing end of the photographing assembly 2 is oriented toward the main body 1. A resting board 3 is provided in the main body 1. The resting board 3 is configured to carry birds. The bird bath further includes a fountain device 5. The fountain device 5 is mounted in the main body 1. Water sprayed by the fountain device 5 flows into the main body 1 for birds to drink and play.

In this embodiment, a horizontal height of the resting board 3 gradually increases from the edge to the center of the resting board 3, thereby making it convenient for birds to choose a suitable water level and avoid drowning. Specifically, the resting board 3 is in a four-level stepped shape. A corresponding number of steps may be set according to actual situations. The edge of the resting board 3 is provided with a clearance opening 31, through which a finger can extend in conveniently, thereby facilitating detachment and assembling of the resting board 3. Preferably, the resting board 3 includes a plurality of arcuate blocks 3a. The plurality of arcuate blocks 3a are connected in tandem to form the resting board 3. The edge of each arcuate block 3a is provided with a clearance opening 31.

It can be understood that in this embodiment, the resting board 3 is stacked on the bottom of the main body 1. In other words, a bottom plate 101 is disposed at the bottom of the main body 1, and a peripheral plate 102 extending upward from the bottom plate 101 is disposed at the edge of the main body. A bathing trough is formed between the bottom plate 101 and the peripheral plate 102. In the bathing trough, birds can move and bathe. The resting board 3 and the bottom plate 101 are stacked up. Definitely, in other embodiments, the resting board 3 may be integrally formed with the bottom plate 101 instead, or the bottom plate 101 may serve as the resting board 3.

The bottom of the main body 1 is detachably connected to a support assembly 4. The support assembly 4 includes a vertical post 41 extending along a vertical direction. At the top of the vertical post 41, a pedestal 42 is connected. At the bottom of the vertical post 41, a drill bit 43 is connected. A support seat 44 is sleeved onto the vertical post 41. Preferably, the vertical post 41 is generally formed by connecting a plurality of straight cylindrical tubes in tandem. The straight cylindrical tubes may be connected by means of threaded connection, plug-connection, or pin connection of the tubes, or by other detachable connection means. The connection means is not described here exhaustively. An appropriate number of straight cylindrical tubes may be selected according to actual needs and spliced to form a vertical post 41 of a desired length, thereby facilitating detachment, assembling, and transportation, and reducing transportation cost. Definitely, the vertical post 41 may be integrally formed instead, with an appropriate length required by the user.

Specifically, the pedestal 42 is connected to the vertical post 41 by a pin 47. A rope 48 bound to the pin 47 is disposed on the vertical post 41 to prevent the pin 47 from being lost and facilitate detachment and assembling. The drill bit 43 is fixed onto the lowest straight cylindrical tube to ensure a secure connection. The vertical post 41 is provided with an assembly hole 4111. The assembly hole 4111 penetrates the vertical post along a radial direction of the vertical post 41. A rotation rod 49 is inserted into the assembly hole 4111.

The support seat 44 extends along a radial direction of the vertical post 41. On the support seat 44, a fastener 45 is connected. The fastener 45 is configured to lock or unlock the support seat 44 relative to the vertical post 41. The fastener 45 is preferably a butterfly screw. Preferably, the support seat 44 is generally annular, facilitating sleeving onto the vertical post 41. Alternatively, the support seat 44 may be a ring shape formed by connecting a plurality of arcuate plates. In this embodiment, preferably, the support seat is formed by hinging two arcuate plates together, and is foldable to save storage space. It is worth noting that an arc angle occupied by each arcuate plate within one support seat 44 is usually equal, so as to ensure folding to the smallest size. A heavy object may be placed on the support seat 44 to make the support seat more stable. Alternatively, the support seat 44 may be designed as an annular trough in which flowers, plants, or aquatic organisms may be cultivated, so as to achieve diverse functions.

An adjustment piece 46 is disposed at the bottom of the main body 1. A plurality of adjustment pieces 46 are circumferentially spaced apart around an axis of the vertical post 41. A first end of each adjustment piece 46 fits a stopper of the pedestal 42. A second end of the adjustment piece 46 passes through the pedestal 42 and is screwed to the main body 1. The adjustment pieces 46 are preferably Phillips screws. The pedestal 42 is provided with arcuate through holes 421 in one-to-one correspondence with the plurality of adjustment pieces 46. A head diameter of each arcuate through-hole 421 is greater than a diameter of a first end of the adjustment piece 46. A tail diameter of the arcuate through-hole 421 is greater than a diameter of a second end of the adjustment piece 46 but less than the diameter of the first end of the adjustment piece 46. A spring leaf 422 is disposed protrusively on an inner wall at a tail end of the arcuate through-hole 421.

A specific usage method of the support assembly 4 is as follows: For a hard ground, the pedestal 42 and the support seat 44 may be mounted at two ends of the vertical post 41 respectively without requiring a drill bit 43, and the support assembly is mounted by just inserting a pin 47, tightening a fastener 45, and placing the support seat 44 flat on the hard ground; for a loose or soft ground, the user needs to insert a rotation rod 49 into an assembly hole 4111 first until the drill bit 43 contacts the ground, and then the user rotates the rotation rod 49 so that the drill bit 43 rotates and drills into the ground; after the drill bit reaches a suitable depth, the user removes the rotation rod 49, pulls on the support seat 44, tightens the fastener 45, and finally, puts the assembly into the pedestal 42, and inserts the pin 47, thereby completing the mounting of the support assembly 4.

The main body 1 is preferably made of transparent materials such as transparent plastic or glass.

The photographing assembly 2 includes a housing 21. A camera 22 is fitted in the housing 21. The housing 21 is provided with a window 211 adapted to a lens of the camera 22. A snap slot 212 is provided on the exterior of the housing 21. A snap buckle 111 adapted to the snap slot 212 is provided on the inner wall of the socket 11. The top edge of the housing 21 is provided with a flange 213 extending along a horizontal direction. The top of the flange 213 is overlaid with a solar panel 23 electrically connected to the camera 22. A notch 112, adapted to the window 211, is provided on a sidewall of the socket 11.

It is worth noting that the camera 22 includes two lenses and two focal lengths, implements motion detection based on a passive infrared sensor (PIR), uses AI technology to implement automatic recognition and track bird movements, and is powered by clean energy from a solar panel. When the photographing assembly 2 is mounted in the socket 11, the user just needs to insert the housing 21 into the socket 11. The snap slot 212 fits the snap buckle 111 to secure the housing 21 in place, thereby completing the assembling.

In this embodiment, a standard interface 100 is disposed in the main body 1. The standard interface 100 is configured to adapt to the fountain device 5 in a detachable and replaceable manner. The standard interface 100 may, as required, be designed as a threaded hole of a preset specification. A threaded post of a unified preset specification may be disposed on the fountain device 5. In this way, the fountain device 5 can adapt to the standard interface 100, thereby facilitating the detachment and replacement of the fountain device 5. Definitely, understandably, the standard interface 100 may be designed to include a plurality of standard pin holes, and a plurality of standard pin rods may be uniformly disposed on the fountain device 5. By using the plug connection between the pin rod on the fountain device 5 and the pin hole, the fountain device 5 can be mounted on the main body 1, and when the fountain device 5 needs to be replaced, the pin rod is pulled out from the pin hole to implement the detachment and replacement of the fountain device 5.

In some embodiments, the fountain device 5 is mounted in the main body. The fountain device 5 is configured to spray water from the main body 1 from low to high, thereby forming a fountain landscape. The fountain is also available for birds to bathe. It is worth noting that the photographing end of the photographing assembly 2 is oriented toward the fountain device 5.

Specifically, the standard interface 100 may be disposed at the bottom of the main body 1. When the fountain device 5 is connected to the standard interface 100, the fountain device 5 can roughly protrude upward from the bottom of the main body 1, thereby facilitating the fountain device 5 to provide corresponding additional functions in the main body. The additional functions that the fountain device 5 can provide for the main body 1 may include additional functions such as sound, light, gas pumping, water pumping, oxygen supply, sterilization, and disinfection. The fountain device 5 may provide the corresponding additional functions in the main body 1 through corresponding built-in functional devices.

In an embodiment, the standard interface 100 is disposed at the center of the main body 1. The standard interface 100 is provided with an accessory slot 12. The fountain device 5 is detachably adapted to the accessory slot 12. The resting board 3 is disposed around the accessory slot 12.

Specifically, a through-hole is provided at the bottom center of the main body 1. The standard interface 100 is disposed in the through-hole. The accessory slot 12 is formed at an end of the through-hole, the end being away from the opening of the bathing trough. A part of the fountain device 5 is inserted into the through-hole, thereby enabling the fountain device 5 to adapt to the accessory slot 12.

In some embodiments, a sealing platform 121 is disposed around an end of the through-hole at the bottom of the main body 1, the end being away from the accessory slot 12. The fountain device 5 is provided with a docking platform that abuts against the sealing platform 121. A sealing element 6 may be disposed between the sealing platform 121 and the docking platform to prevent water in the main body 1 from leaking from an assembly clearance between the fountain device 5 and the main body 1. A boss of the fountain device 5 is disposed on the docking platform. The boss is in plug-in fit with the accessory slot 12 so that the fountain device 5 can adapt to the standard interface 100.

Understandably, the fountain device 5 is provided with a water inlet 511, a water outlet 518 separated from the water inlet 511 and configured to sprinkle water, and a water pump 52 located between the water inlet 511 and the water outlet 518. On the accessory slot 12, the fountain device 5 is detachably connected, and the sealing element 6 is press-fitted between the fountain device 5 and the accessory slot 12. The fountain device 5 includes a shell 51 and a water pump 52. The inner wall of the accessory slot 12 and the outer wall of the shell 51 are provided with matching threads. The assembling can be implemented by just screwing the shell 51 into the accessory slot 12 to press-fit the sealing element 6 between the fountain device 5 and the slot wall of the accessory slot 12. The water pump 52 is disposed inside the shell 51. An outlet pipe 53 connected to the water pump 52 is disposed at the top of the shell 51. The water outlet 518 is disposed on the outlet pipe 53. A water inlet 511 is disposed on a side of the shell 51. The top of the shell 51 is overlaid with a photovoltaic panel 54 electrically connected to the water pump 52. The photovoltaic panel 54 is disposed at an end of the fountain device 5, the end being away from the main body 1. Understandably, in some embodiments, a heating unit may be connected between the water pump 52 and the water inlet 511. In winter or when the ambient temperature is low, the water may be heated to keep the water temperature at a level suitable for birds, thereby meeting the needs of different seasons and different birds. It is worth noting that an ozone disinfection module and a filter purification system may be externally connected to ensure water quality safety in the main body 1. A water change module may be added to implement automatic regular water change, thereby further ensuring high water quality, attracting more birds to bathe, and greatly increasing the probability of the photographing assembly 2 capturing and recording interesting moments.

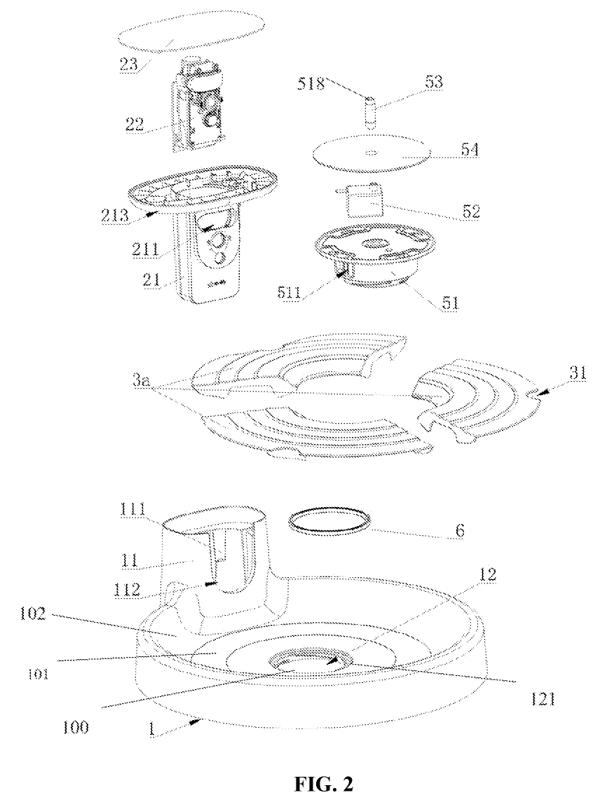

Referring to FIG. 2, it is worth noting that the fountain device 5 is provided with a snap-fit slot. The shape of the snap-fit slot matches the shape of the photovoltaic panel 54. The photovoltaic panel is accommodated in the snap-fit slot, so that the photovoltaic panel 54 is flush with the edge of the main body 1, thereby increasing the aesthetics of the fountain device 5 and the photovoltaic panel 54, and also saving space in the bird bath, and reducing the height of the outlet pipe 53. This enables control of the formed fountain to avoid spray out of the main body 1, and ensures that the fountain does not splash passers-by. Understandably, without considering space saving and aesthetic improvement, the snap-fit slot may be not disposed. All technical solutions in which the bird bath includes the fountain device 5 and the photovoltaic panel 54 fall within the protection scope hereof.

Referring to FIG. 1 and FIG. 2, it is worth noting that the water pump 52 is disposed on the central axis of the main body 1, and the water outlet 518 is also disposed on the central axis of the main body 1. The outlet pipe 53 can be directly connected to the water pump 52 without a need to additionally dispose a water pipe connecting the water pump 52 and the outlet pipe 53, thereby reducing the production cost of the bird bath. Understandably, without considering reduction of the production cost of the bird bath, the water pump 52 may be not disposed on the central axis of the main body 1. All technical solutions in which the water pump 52 is connected to the outlet pipe 53 fall within the protection scope hereof.

The working principles of this application are as follows: The main body 1 may be used alone, the main body is directly placed in a suitable place, the resting board 3 is disposed in the main body 1, and the main body 1 contains clean water for normal use.

When a user needs to observe and record birds, the user may mount the photographing assembly 2 in the socket 11. The photographing assembly 2 can, in real time, automatically record the pictures of birds bathing. Alternatively, the fountain device 5 may be mounted on the accessory slot 12 to add fun for birds.

When the support assembly 4 needs to be used, the user mounts the support assembly 4 first according to the ground conditions. For a specific mounting process, reference may be made to the above description, and details are omitted here. Subsequently, the user screws a second end of each adjustment piece 46 to the bottom of the main body 1, and then places the main body 1 on the pedestal 42, and at the same time, aligns a first end of the adjustment piece 46 with a head end of the arcuate through-hole 421. Immediately afterward, the user rotates the main body 1 to slide the adjustment piece 46 to a tail end of the arcuate through-hole 421. Under the action of the spring leaf 422, the adjustment piece will be firmly clasped. Finally, the user observes whether the main body 1 is relatively horizontal, and may twist the adjustment piece 46 to adjust the main body 1 to a horizontal state.

In other embodiments, as shown in FIG. 7, the bird bath further includes a temperature regulation module 210. The temperature regulation module 210 is configured to heat, cool, or maintain a constant temperature for the main body 1 or gas and/or water in the main body 1. The bird bath is provided with an accessory shell 220. A boss adaptable to the accessory slot 12 may be disposed at the bottom of the accessory shell 220. The temperature regulation module 210 is accommodated inside the accessory shell 220. The temperature regulation module 210 is provided with a temperature sensing unit, a heating unit 2102, a heat dissipation unit 2103, and a control chip 2104. The control chip 2104 is electrically connected to the temperature sensing unit, the heating unit 2102, and the heat dissipation unit 2103. When the temperature sensing unit senses that the water temperature in the main body 1 is higher than a preset range, the control chip 2104 controls the heat dissipation unit 2103 to cool the water in the main body 1. When the temperature sensing unit senses that the water temperature in the main body 1 is lower than a preset range, the control chip 2104 controls the heating unit 2102 to heat the water in the main body 1.

In some embodiments, the temperature regulation module 210 is provided with a first temperature sensing unit 2101a and a second temperature sensing unit 2101b. The first temperature sensing unit 2101a is disposed at the bottom of the accessory shell 220 to facilitate contact with the water in the main body 1. The second temperature sensing unit 2101b is disposed at the top of the accessory shell 220 to facilitate contact with the air in the main body 1. The first temperature sensing unit 2101a can sense the water temperature in the main body 1. The second temperature sensing unit 2101b can sense the air temperature in the main body 1. The temperature regulation module 210 is further provided with a heating unit 2102 and a heat dissipation unit 2103. The heating unit 2102 is mainly formed of electrical heating wires. The heat dissipation unit 2103 is mainly formed of heat dissipation conductors and fans. The bird bath is further provided with a first heat conductor 2105 and a second heat conductor 2106. The first heat conductor 2105 is disposed at the bottom of the accessory shell 220, and is configured to quickly exchange heat with the water in the main body 1. The second heat conductor 2106 is disposed at the top of the accessory shell 220, and is configured to quickly exchange heat with the gas in the main body 1. The heating unit 2102 is thermally coupled with the first heat conductor 2105. The heat dissipation unit 2103 is thermally coupled with the second heat conductor 2106. The control chip 2104 is electrically connected to the first temperature sensing unit 2101a, the second temperature sensing unit 2101b, the heating unit 2102, and the heat dissipation unit 2103. When the first temperature sensing unit 2101a senses that the water temperature in the main body 1 is lower than a preset range, the control chip 2104 controls the heating unit 2102 to heat up, and the heat is conducted to the water in the main body 1 by the first heat conductor 2105, so that the water temperature in the main body 1 rises quickly. When the first temperature sensing unit 2101a senses that the water temperature in the main body 1 is higher than a preset range, the control chip 2104 controls the heat dissipation unit 2103 to cool the first heat conductor 2105. The first heat conductor 2105 absorbs the heat of the water in the main body 1, so that the water temperature in the main body 1 drops quickly. The first heat conductor 2105 may be a capillary heat-conducting copper tube structure that conducts heat efficiently. The control chip 2104 can switch between the heating of the heating unit 2102 and the heat dissipation of the heat dissipation unit 2103 alternately, and control the water temperature in the main body 1 to maintain a constant temperature state to achieve a constant temperature of the water in the main body 1. When the second temperature sensing unit 2101b senses that the gas temperature in the main body 1 is lower than a preset range, the control chip 2104 controls the heating unit 2102 to heat up, and the heat is conducted to the gas in the main body 1 by the second heat conductor 2106, so that the gas temperature in the main body 1 rises quickly. When the second temperature sensing unit senses that the gas temperature in the main body 1 is higher than a preset range, the control chip 2104 controls the heat dissipation unit 2103 to cool the second heat conductor 2106. The second heat conductor 2106 absorbs the heat of the gas in the main body 1, so that the gas temperature in the main body 1 drops quickly. The second heat conductor 2106 may be a capillary heat-conducting copper tube structure that conducts heat efficiently. The control chip 2104 can switch between the heating of the heating unit 2102 and the heat dissipation of the heat dissipation unit 2103 alternately, and control the gas temperature in the main body 1 to maintain a constant temperature state to achieve a constant temperature of the gas in the main body 1. Understandably, the temperature regulation module 210 may be provided with only a first temperature sensing unit 2101a, and is configured to regulate only the water temperature in the main body 1. Alternatively, the temperature regulation module 210 may be provided with only a second temperature sensing unit 2101b, and is configured to regulate only the gas temperature in the main body 1. The temperature regulation module 210 may be provided with only a heating unit 2102, and is configured to only increase the water or gas temperature in the main body 1. Alternatively, the temperature regulation module 210 may be provided with only a heat dissipation unit 2103, and is configured to only decrease the water or gas temperature in the main body 1. The heat provided by the heating unit 2102 can defrost the water in the main body 1 to prevent icing.

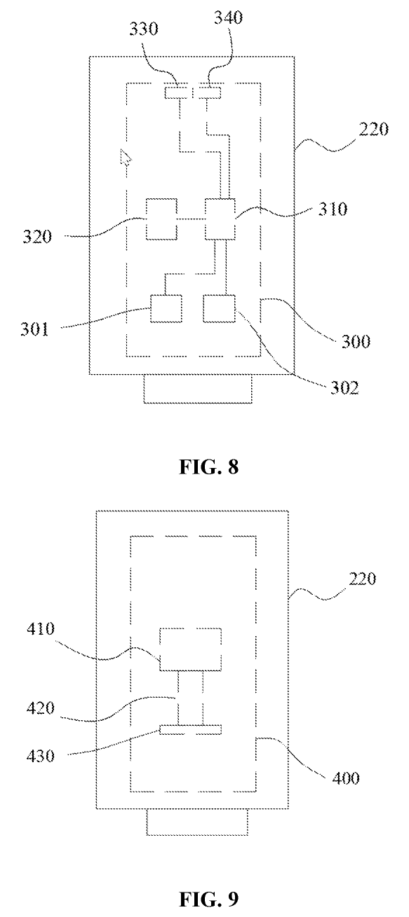

In other embodiments, as shown in FIG. 8, the bird bath further includes a light emitter 300 configured to provide light therapy for birds in the main body 1. The light emitter 300 emits light into the main body 1. The light may be irradiated to the water in the main body 1 or a partial region of the main body 1 to provide a light environment for birds in the main body 1. The light can be directly irradiated onto bird bodies. The light may be adjusted to different light rays according to the birds' preferences to assist the bird growth. The light may also be irradiated to other objects in the main body 1 to assist in providing an environment suitable for bird growth. The light emitter 300 is provided with a light processing chip 310, a program memory 320, an ambient light sensor 330, and an optical proximity sensor 340. The ambient light sensor 330 can sense the ambient light conditions of the main body 1. The optical proximity sensor 340 is configured to sense whether birds are approaching the main body 1. The program memory 320 is configured to store an executable program. The light processing chip 310 is configured to, based on information sensed by the ambient light sensor 330 and the optical proximity sensor 340 and a preset executable program, control the light emitter 300 to emit light.

In some embodiments, the light emitter 300 is provided with an ultraviolet light-emitting unit 301 and/or a white light-emitting unit 302. The ultraviolet light-emitting unit 301 is configured to emit ultraviolet rays capable of disinfecting and sterilizing the interior of the main body 1. The white light-emitting unit 302 is configured to emit full-spectrum light that simulates sunlight. The light processing chip may control, at preset intervals, the ultraviolet light-emitting unit 301 to emit ultraviolet rays to implement disinfection and sterilization for the water in the main body 1, thereby providing a favorable growth environment for birds. The light processing chip 310 can control, at preset time intervals, the white light-emitting unit 302 to emit full-spectrum light to assist bird growth, where the control is exercised when the optical proximity sensor 340 senses that a bird is approaching the main body 1 or when the ambient light sensor 330 senses that the ambient light is weak.

In other embodiments, as shown in FIG. 9, the bird bath further includes a vibrator 400. The vibrator 400 is configured to provide vibration waves for water in the main body 1. The vibrator 400 is provided with a high-frequency motor 410, a transmission mechanism 420, and a vibration plate 430. The high-frequency motor 410 drives, through the transmission mechanism 420, the vibration plate 430 to vibrate at high frequency. The vibration plate 430 contacts the water in the main body 1, thereby enabling high-frequency vibration waves to be provided for the water in the main body 1. With vibration of the high-frequency vibration waves, the water in the main body 1 is not prone to provide an incubation environment for mosquitoes, thereby preventing mosquitoes from breeding in the water in the main body 1. With the high-frequency vibration of the vibration plate 430, the water in the main body 1 is more prone to contact oxygen, thereby avoiding bacterial contamination in the water in the main body 1.

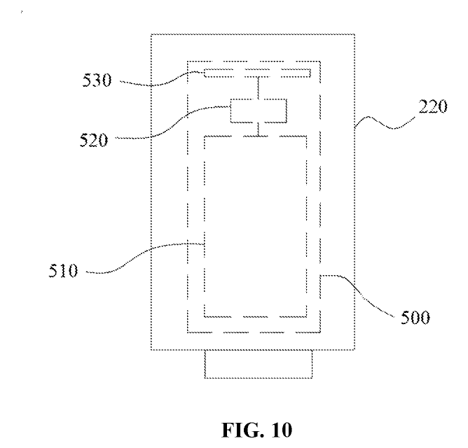

In other embodiments, as shown in FIG. 10, the bird bath further includes a spray humidifier 500. The spray humidifier 500 is configured to spray the water in the main body 1 as mist. The spray humidifier 500 is provided with a water tank 510, a high-pressure pump 520, and a mist nozzle 530. The high-pressure pump 520 is connected to the water tank 510, so as to apply high pressure to the water in the water tank 510 and pump the water to the mist nozzle 530. In this way, particulate water mist is formed at the mist nozzle 530, and the mist is sprayed into the main body 1 to ensure a favorable humidity inside the main body 1 and near the main body 1.

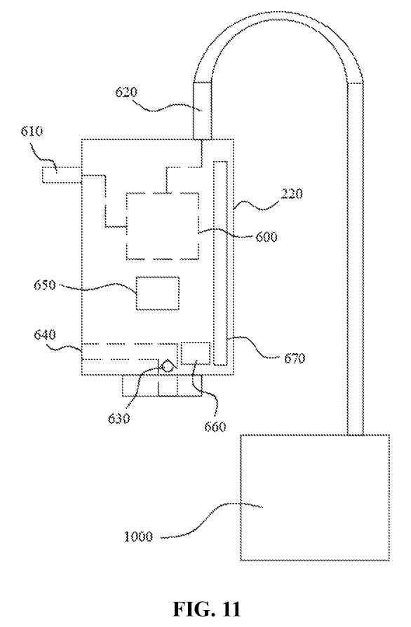

In other embodiments, as shown in FIG. 11, the bird bath further includes a water pump 600. A water tank 1000 is mountable outside the main body 1. The water tank 1000 is configured to store water for birds to drink. The water pump 600 is able to pump the water from the water tank 1000 into the main body 1. Specifically, the bird bath is provided with a water supply pipe 610 on the accessory shell 220. The water supply pipe 610 is configured to supply water to the main body 1. The water pump 600 communicates to the water supply pipe 610 inside the accessory shell 220 through a pipeline. The accessory shell 220 is further provided with a water delivery pipe 620. The water delivery pipe 620 is connected to the water tank 1000, so as to transmit water to the water supply pipe 610 as pumped by the water pump 600. The water pump 600 communicates to the water delivery pipe 620 through a pipeline.

The bird bath further includes a drain valve 630. The drain valve 630 is configured to quickly drain the water in the main body 1 out of the main body 1. The accessory shell 220 is provided with a drain port 640 adjacent to the bottom of the main body 1. A drain pipe communicating to the drain port 640 is disposed in the accessory shell 220. The drain valve 630 is disposed on the drain pipe. The bird bath is provided with a water supply processor 650 and a water quality sensor 660. The water supply processor 650 can control the drain valve 630 based on water quality information in the main body 1 sensed by the water quality sensor 660, so as to quickly drain the water out of the main body 1. The bird bath is further provided with a water level sensor 670. When the water level sensor 670 senses that the water in the main body 1 is about to dry up, the water supply processor 650 controls the water pump 600 to work, and at the same time, controls the drain valve 630 to close, so as to pump the water in the water tank 1000 into the main body 1. When the water level sensor 670 senses that the water in the main body reaches a preset full position, the water supply processor controls the water pump 600 to stop working.

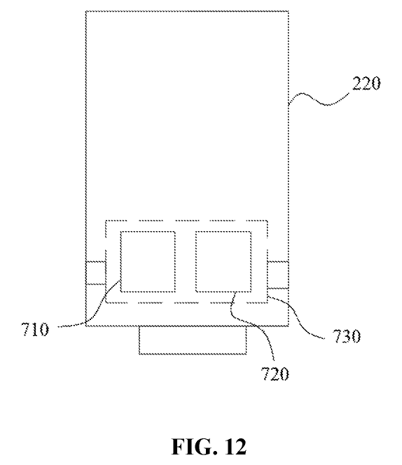

In other embodiments, as shown in FIG. 12, the bird bath further includes an ozone disinfection unit 710 and a filter purification unit 720. The ozone disinfection unit 710 and the filter purification unit 720 are configured to filter, purify, and disinfect the water in the main body 1. The bird bath is provided with a filter cavity 730 communicating to the interior of the main body 1. The ozone disinfection unit 710 and the filter purification unit 720 are disposed in the filter cavity 730. The bird bath is further provided with a pump body to pump the water in the main body 1 into the filter cavity 730. In this way, the water in the main body 1 is pumped back into the main body 1 after being purified and disinfected by the ozone disinfection unit 710 and the filter purification unit 720.

Understandably, the bird bath in an embodiment of this application is not limited to the forms described in various embodiments above, but may be any combination of the above embodiments, so that the bird bath integrates diverse functions. For example, the bird bath may integrate the fountain device, the water pump, the ozone disinfection unit, and the filter purification unit, so that the bird bath serves diverse integrated functions such as bird bathing, automatic bird water dispensing, automatic water supply and drainage, and automatic disinfection.

A person skilled in the art can easily conceive other technical solutions of this application after reading this specification and practicing the inventive concept hereof. This application is intended to cover any variations, uses, or adaptations of this application. Such variations, uses or adaptations follow the general principles of this application and include well-known common knowledge or conventional technical means in this technical field that are not disclosed by this application. The specification and embodiments are merely illustrative, and the real scope and spirit of this application are subject to the claims. Understandably, this application is not limited to the precise structures described above and shown in the drawings, to which various modifications and changes may be made without departing from the scope hereof. The protection scope of this application is subject to the claims appended hereto.

What is claimed is:

1. A bird bath, comprising:
a main body, provided with a bathing trough for birds to bathe;
a fountain device, mounted in the main body; and
a photographing assembly, disposed around the main body and configured to photograph the birds, wherein a photographing end of the photographing assembly is oriented toward the fountain device.

2. The bird bath according to claim 1, wherein a standard interface is disposed in the main body.

3. The bird bath according to claim 2, wherein the standard interface is configured to adapt to the fountain device in a detachable and replaceable manner; the standard interface is disposed at a center of the main body, the standard interface is provided with an accessory slot, and the fountain device is detachably adapted to the accessory slot.

4. The bird bath according to claim 1, wherein the fountain device is provided with a water inlet, a water outlet separated from the water inlet and configured to sprinkle water, and a water pump located between the water inlet and the water outlet.

5. The bird bath according to claim 4, wherein the bird bath further comprises a photovoltaic panel, the photovoltaic panel is disposed at an end of the fountain device, the end being away from the main body, and the photovoltaic panel is electrically connected to the water pump.

6. The bird bath according to claim 4, wherein a sealing element is disposed between the fountain device and the main body, and the sealing element is configured to prevent the water in the main body from leaking from an assembly clearance between the main body and the fountain device.

7. The bird bath according to claim 1, wherein the photographing assembly comprises a housing and a camera, the camera is disposed in the housing; and/or
a top edge of the housing is provided with a flange extending along a horizontal direction, and a top of the flange is overlaid with a solar panel electrically connected to the camera.

8. The bird bath according to claim 1, wherein the bird bath further comprises a temperature regulation module, and the temperature regulation module is configured to heat, cool, or maintain a constant temperature for the main body or gas and/or water in the main body.

9. The bird bath according to claim 1, wherein the bird bath further comprises a light emitter configured to provide light therapy for birds in the main body.

10. The bird bath according to claim 9, wherein the light emitter comprises an ultraviolet light-emitting unit and/or a white light-emitting unit, the ultraviolet light-emitting unit is configured to emit ultraviolet rays capable of disinfecting and sterilizing an interior of the main body, and the white light-emitting unit is configured to emit full-spectrum light that simulates sunlight.

11. The bird bath according to claim 1, wherein the bird bath further comprises a vibrator, and the vibrator is configured to provide vibration waves for water in the main body.

12. The bird bath according to claim 1, wherein the bird bath further comprises a spray humidifier, and the spray humidifier is configured to spray water mist into the main body.

13. The bird bath according to claim 1, wherein the bird bath further comprises a water pump, a water tank is mountable outside the main body, the water tank is configured to store water for birds to drink, and the water pump is able to pump the water from the water tank into the main body.

14. The bird bath according to claim 13, wherein the bird bath further comprises a drain valve, and the drain valve is configured to quickly drain the water from the main body.

15. The bird bath according to claim 1, wherein the bird bath further comprises an ozone disinfection unit and a filter purification unit, and the ozone disinfection unit and the filter purification unit are configured to filter, purify, and disinfect water in the main body.

16. The bird bath according to claim 1, wherein the bird bath further comprises a water level sensor, and the water level sensor is configured to sense a water level in the main body.

17. The bird bath according to claim 1, wherein the bird bath further comprises a water quality sensor, and the water quality sensor is configured to sense water quality information in the main body.

18. The bird bath according to claim 1, wherein a bottom of the main body is detachably connected to a support assembly, and the support assembly comprises a vertical post extending along a vertical direction.

19. The bird bath according to claim 1, wherein the bird bath further comprises a resting board, the resting board is disposed in the main body, and the resting board is configured to carry birds.

20. The bird bath according to claim 1, wherein an edge of the main body is provided with a socket, and the photographing assembly is detachably connected to the socket.
